(19) United States
(12) Patent Application Publication
(10) Pub. No.: US 2013/0108860 A1
(43) Pub. Date: May 2, 2013

(54) Surface Modification of Pressure-Sensitive Adhesives with Nanoparticles

(71) Applicants: Zhong Chen, Woodbury, MN (US); Belma Erdogan-Haug, St. Paul, MN (US)

(72) Inventors: Zhong Chen, Woodbury, MN (US); Belma Erdogan-Haug, St. Paul, MN (US)

(73) Assignee: 3M INNOVATIVE PROPERTIES COMPANY, ST. PAUL, MN (US)

(21) Appl. No.: 13/805,936

(22) PCT Filed: Jun. 17, 2011
(86) PCT No.: PCT/US11/40855

§ 371 Date: Dec. 20, 2012

Related U.S. Application Data
(60) Provisional application No. 61/359,934, filed on Jun. 30, 2010.

(51) Int. Cl. C09J 11/06

(52) U.S. Cl. CPC C09J 11/06; Y10S 977/773; B82Y 30/00
USPC 428/323; 427/256; 428/332; 428/336; 977/773

(57) ABSTRACT

Adhesive articles having surface-modified nanoparticles located on or near at least one surface of a layer of pressure sensitive adhesive are described. Methods of making such adhesive articles are also described.

### FIELD

The present disclosure relates to pressure sensitive adhesives. In particular, the present disclosure relates to pressure sensitive adhesive having nanoparticles incorporated into the bonding surface of the adhesive.

### SUMMARY

Briefly, in one aspect, the present disclosure provides an adhesive article comprising a layer of a pressure sensitive adhesive comprising a first surface and a second surface, and a plurality of surface modified nanoparticles having an average diameter of Davg as measured by the TEM method. In some embodiments, at least 80% by weight of the surface modified nanoparticles are located within at least one of a first region extending from on the first surface to a depth of five times Davg from the first surface and a second region extending from on the second surface to a depth of five times Davg from the second surface. In some embodiments, at least 80% by weight of the surface modified nanoparticles are located within a first region extending from on the first surface to a depth of five times Davg from the first surface. In some embodiments, at least 80% by weight of the surface modified nanoparticles are located within at least one of a first region extending from on the first surface to a depth 500 nm from the first surface and a second region extending from on the second surface to a depth of 500 nm from the second surface. In some embodiments, at least 80% by weight of the surface modified nanoparticles are located within a first region extending from on the first surface to a depth of 500 nm from the first surface.

In some embodiments, the surface modified nanoparticles comprise a silica core. In some embodiments, the surface modified nanoparticles further comprise a surface modifying agent comprising a binding group attached to the surface of the core and a compatiblizing group. In some embodiments, the difference between the solubility parameters of the pressure sensitive adhesive and the solubility parameter of the compatiblizing group is no more than 4 J1/2 cm-3/2 as determined by the Additive Group Contribution Method.

In some embodiments, the adhesive is crosslinked.

In some embodiments, Davg is no greater than 250 nm. In some embodiments, Davg is at least 10 nm. In some embodiments, Davg is between 20 and 100 nm, inclusive.

In another aspect, the present disclosure provides methods of preparing an adhesive article comprising a layer of a pressure sensitive adhesive comprising a first surface and a second surface. In some embodiments, the method comprises applying a solution comprising surface-modified nanoparticles having an average diameter of Davg as measured by the TEM method in a solvent to at least one of the first and second surfaces of the layer and drying the applied solution. In some embodiments, at least 80% by weight of the surface modified nanoparticles are located within at least one of a first region extending from on the first surface to a depth of five times Davg from the first surface and a second region extending from on the second surface to a depth of fives Davg from the second surface. In some embodiments, at least 80% by weight of the surface modified nanoparticles are located within a first region extending from on the first surface to a depth of five times Davg from the first surface. In some embodiments, at least 80% by weight of the surface modified nanoparticles are located within at least one of a first region extending from on the first surface to a depth 500 nm from the first surface and a second region extending from on the second surface to a depth of 500 nm from the second surface. In some embodiments, at least 80% by weight of the surface modified nanoparticles are located within a first region extending from on the first surface to a depth of 500 nm from the first surface.

In some embodiments, the solution comprises between 0.5 and 2 wt. % surface-modified nanoparticles. In some embodiments, the solvent system swells but does not dissolve the pressure sensitive adhesive.

The above summary of the present disclosure is not intended to describe each embodiment of the present invention. The details of one or more embodiments of the invention are also set forth in the description below. Other features, objects, and advantages of the invention will be apparent from the description and from the claims.

### BRIEF DESCRIPTION OF THE DRAWINGS

FIG. 1 illustrates an exemplary adhesive article according to some embodiments of the present disclosure.

FIG. 2 illustrates another exemplary adhesive article according to some embodiments of the present disclosure.

### DETAILED DESCRIPTION

Pressure sensitive adhesives (PSAs) and their benefits and limitations are well-known. PSAs have been used to bond to a wide variety of substrates including both high surface energy (HSE) and low surface energy (LSE) substrates. Generally, improvements in the bonding properties of a PSA to range of substrates have been achieved by chemically altering the bonding surfaces of the adherends themselves or tuning the bulk rheological properties of the PSA. However, it remains a challenge to achieve desired bond strengths between a PSA and LSE substrates.

Nanoparticles, including surface-modified nanoparticles are known. Such nanoparticles have been incorporated in to a variety of resins including adhesives and pressure sensitive adhesives. Generally, the nanoparticles are incorporated into the bulk adhesive precursor, the nanoparticle-containing adhesive precursor is coated onto a substrate, and the adhesive precursor is dried or otherwise cured to form the PSA. With this conventional approach, the nanoparticles are dispersed throughout the thickness of the resulting PSA layer. In contrast, the present inventors have discovered that surprising improvements in a variety of adhesive properties can be achieved by selectively locating nanoparticles only on or near the surface of the PSA.

In some embodiments, the PSA comprises an acrylic PSA. Generally, the acrylic adhesive comprises an acrylic copolymer comprising the reaction product of a mixture of a first alkyl (meth)acrylate and a vinyl carboxylic acid. As used herein, “(meth)acrylate” refers to an acrylate and/or methacrylate. For example, butyl (meth)acrylate refers to butyl acrylate and/or butyl methacrylate. In some embodiments, the mixture may also include a crosslinking agent.

In some embodiments, the alkyl group of the first alkyl (meth)acrylate contains 4 to 18 carbon atoms. In some embodiments, this alkyl group contains at least 5 carbon atoms. In some embodiments, this alkyl group contains no greater than 8 carbon atoms. In some embodiments, the alkyl group of the first alkyl (meth)acrylate has eight carbon atoms, e.g., isooctyl (meth)acrylate and/or 2-ethylhexyl (meth)acrylate.

Exemplary vinyl carboxylic acids that may be useful in some embodiments of the present disclosure include acrylic acid, methacrylic acid, itaconic acid, maleic acid, fumaric acid, and β-carboxyethylacrylate.

In some embodiments, the acrylic copolymers of the present disclosure comprise at least 2% by weight, in some embodiments, at least 3% by weight of the vinyl carboxylic acid based on the total weight of the alkyl (meth)acrylates and the vinyl carboxylic acids. In some embodiments, the acrylic polymer comprises no greater than 10% by weight, in some embodiments, no greater than 8% by weight, and, in some embodiments, no greater than 5% by weight of the vinyl carboxylic acid. In some embodiments, the acrylic polymer comprises 3-5% by weight, inclusive, of vinyl carboxylic acid based on the total weight of the alkyl (meth)acrylates and the vinyl carboxylic acids. Generally, acrylic adhesives containing such higher levels of a vinyl carboxylic acid are thought to be suitable for bonding to high surface energy substrates such as, e.g., stainless steel.

In some embodiments, the acrylic copolymers of the present disclosure comprise less than 2% by weight, e.g., less than 1% by weight, of the vinyl carboxylic acid based on the total weight of the alkyl (meth)acrylates and the vinyl carboxylic acids. In some embodiments, the acrylic copolymer comprises 0.3 to 1.5% by weight, e.g., 0.5 to 1% by weight, inclusive, of vinyl carboxylic acid based on the total weight of the alkyl (meth)acrylates and the vinyl carboxylic acids.

In some embodiments, the mixture may comprise one or more additional monomers including one or more additional alkyl(meth)acrylates. In some embodiments, the alkyl group of at least one of the alkyl (meth)acrylates contains no greater than 4 carbon atoms. In some embodiments, the alkyl group of at least one alkyl (meth)acrylate has 4 carbon atoms, e.g., butyl (meth)acrylate. In some embodiments, the alkyl group of at least one alkyl (meth)acrylate has 1-2 carbon atoms, e.g., methyl acrylate and/or ethyl acrylate.

In some embodiments, a non-polar alkyl(meth)acrylate may be used. As used herein, a non-polar monomer is a monomer whose homopolymer has a solubility parameter as measured by the Fedors' method of not greater than 10.50. The inclusion of a non-polar monomer improves the low energy surface adhesion of the adhesive. It also improves the structural properties of the adhesive (e.g., cohesive strength). Examples of suitable non-polar monomers and their Fedors' solubility parameter ((cal/cm³)^{1/2}) include 3,3,5 trimethylcyclo-hexyl acrylate (9.35), cyclohexyl acrylate (10.16), isobornyl acrylate (9.71), N-octyl acrylamide (10.33), butyl acrylate (9.77), and combinations thereof.

In some embodiments, the PSA comprises a block copolymer. In some embodiments, the block copolymer is a styrenic block copolymer, i.e., a block copolymer comprising at least one styrene hard segment, and at least one elastomeric soft segment. Exemplary styrenic block copolymers include dimmers such as styrene-butadiene (SB) and styrene-isoprene (SI). Additional exemplary styrenic block copolymers include styrene-isoprene-styrene (SIS), styrene-butadiene-styrene (SBS), styrene-ethylene/butadiene-styrene (SEBS), and styrene-ethylene/propylene-styrene block copolymers. In some embodiments, radial and star block copolymers may be used. Commercially available styrenic block copolymers include those available under the trade designation KRATON from Kraton Polymers LLC. including, e.g., KRATON D SBS and SIS block copolymers; and KRATON G SEBS and SEPS copolymers. Additional commercially available di- and tri-block styrenic block copolymers include those available under the trade designations SEPTON and HYBAR from Kuraray Co. Ltd., those available under the trade designation FINAPRENE from Total Petrochemicals, and those available under the trade designation VECTOR from Dexco Polymers LP.

The PSAs of the present disclosure may contain any of a variety of know additives including, e.g., photoinitiators, curing agents, tackifiers, plasticizers, fillers, flame retardants, dyes, pigments, and the like.

The PSAs of the present disclosure contain surface-modified nanoparticles. Generally, “surface modified nanoparticles” comprise surface treatment agents attached to the surface of a nanometer scale core. In some embodiments, the core is substantially spherical. In some embodiments, the cores are relatively uniform in primary particle size. In some embodiments, the cores have a narrow particle size distribution. In some embodiments, the core is substantially fully condensed. In some embodiments, the core is amorphous. In some embodiments, the core is isotropic. In some embodiments, the particles are substantially non-agglomerated. In some embodiments, the particles are substantially non-aggregated in contrast to, for example, fumed or pyrogenic silica.

As used herein, “agglomerated” is descriptive of a weak association of primary particles usually held together by charge or polarity. Agglomerated particles can typically be broken down into smaller entities by, for example, shearing forces encountered during dispersion of the agglomerated particles in a liquid.

In general, “aggregated” and “aggregates” are descriptive of a strong association of primary particles often bound together by, for example, residual chemical treatment, covalent chemical bonds, or ionic chemical bonds. Further breakdown of the aggregates into smaller entities is very difficult to achieve. Typically, aggregated particles are not broken down into smaller entities by, for example, shearing forces encountered during dispersion of the aggregated particles in a liquid.

As used herein, the term “silica nanoparticle” refers to a nanoparticle having a nanometer scale core with a silica surface. This includes nanoparticle cores that are substantially entirely silica, as well nanoparticle cores comprising other inorganic (e.g., metal oxide) or organic cores having a silica surface. In some embodiments, the core comprises a metal oxide. Any known metal oxide may be used. Exemplary metal oxides include silica, titania, alumina, zirconia, vanadia, chromia, antimony oxide, tin oxide, zinc oxide, ceria, and mixtures thereof. In some embodiments, the core comprises a non-metal oxide.

Generally, the nano-sized silica particles have an average core diameter of less than 500 nm, e.g., less than 250 nm, e.g., less than 100 nm. In some embodiments, the nano-sized silica particles have an average core diameter of at least 5 nm, e.g., at least 10 nm. In some embodiments, the nano-sized silica particles have an average core diameter of between 10 and 100 nm, inclusive, e.g., between 20 and 100 nm, inclusive, or even between 20 and 80 nm, inclusive.

Although other methods such as titration and light scattering techniques may be used, the particle size referred to herein is based on transmission electron microscopy (TEM). Using this technique, TEM images of the nanoparticles are collected, and image analysis is used to determine the particle size of each particle. A count-based particle size distribution is then determined by counting the number of particles having a particle size falling within each of a number of predetermined discrete particle size ranges. The number average particle size is then calculated. One such method is described in U.S. Provisional Application 61/303,406 (“Multimodal Nanoparticle Dispersions, Thunhorst et al., filed 11 Feb. 2010), which is referred to herein as the “TEM Method.”

Commercially available silica nanoparticles include those available from Nalco Chemical Company, Naperville, Ill. (for example, NALCO 1040, 1042, 1050, 1060, 2326, 2327 and 2329); Nissan Chemical America Company, Houston, Tex. (e.g., SNOWTEX-ZL, -OL, -O, -N, -C, -20L, -40, and -50); Admatechs Co., Ltd., Japan (for example, SX009-MIE, SX009-MIF, SC1050-MJM, and SC1050-MLV); Grace GmbH & Co. KG, Worms, Germany (e.g., those available under the product designation LUDOX, e.g., P-W50, P-W30, P-X30, P-T40 and P-T40AS); Akzo Nobel Chemicals GmbH, Leverkusen, Germany (e.g., those available under the product designation LEVASIL, e.g., 50/50%, 100/45%, 200/30%, 200A/30%, 200/40%, 200A/40%, 300/30% and 500/15%; and Bayer MaterialScience AG, Leverkusen, Germany (e.g., those available under the product designation DISPERCOLL S (e.g., 5005, 4510, 4020 and 3030).

The nanoparticles used in the present disclosure are surface treated. Generally, surface-modifying agents for silica nanoparticles are organic species having a first functional group capable of covalently chemically attaching to the surface of a silica nanoparticle, wherein the attached surface-modifying agent alters one or more properties of the nanoparticle.

Generally, the surface-modifying agents of the present disclosure include at least a binding group and a compatiblizing segment:
Comp. Seg.-Binding Group;
   wherein “Com. Seg.” refers to the compatiblizing segment of the surface-modifying agent

The compatiblizing segment is selected to improve the compatibility of the nanoparticles with the pressure sensitive adhesive. Generally, the selection of the compatiblizing group depends on a number of factors including the nature of the pressure sensitive adhesive, the concentration of the nanoparticles, and the desired degree of compatibility. For adhesives based on epoxy resin systems, useful compatiblizing agents include polyalkylene oxides, e.g., polypropylene oxide, polyethylene oxide, and combinations thereof.

In some embodiments, the compatiblizing segment may be selected to provide a positive enthalpy of mixing for the composition containing the surface-modified nanoparticles and the pressure sensitive adhesive. If the enthalpy of mixing is positive, the dispersion of nanoparticles in the adhesive is typically stable. To ensure a positive enthalpy of mixing, the solubility parameter of the compatiblizing segment can be matched to the solubility parameter of the adhesive. In some embodiments, the materials can be selected such that the difference in these solubility parameters is no more than 4 J^{1/2} cm^{-3/2} and, in some embodiments, no more than 2 J^{1/2} cm^{-3/2} as determined according to Properties of Polymers; Their Correlation with Chemical Structure; Their Numerical Estimation and Prediction from Additive Group Contributions, third edition, edited by D. W. Van Krevelen, Elsevier Science Publishers B.V., Chapter 7, 189-225 (1990), i.e., the “Additive Group Contribution Method.”

There are several methods known to determine the solubility parameter of a material such as a compatiblizing segment, an adhesive, or a resin. For example, the solubility parameter of the material can be determined from measurements of the extent of equilibrium swelling of the material in a range of solvents of differing solubility parameters. The solubility parameters of the solvents themselves can be determined from their heats of evaporation. The solubility parameter delta (δ) is related to the cohesive energy E_{coh} and the specific volume V by the relationship δ=(E_{coh}/V)^{1/2}. For solvents of low molecular weight, the cohesive energy is closely related to the molar heat of evaporation ΔHᵥₐₚ according to E_{coh}=ΔHᵥₐₚ−pΔV=ΔHᵥₐₚ−RT. Thus, E_{coh} and δ can be calculated from the heat of evaporation of the solvent or from the course of the vapor pressure as a function of temperature. To determine the solubility parameter of the material, a plot of equilibrium swelling of the material versus the solubility parameter of the solvents is generated. The solubility parameter of the material is defined as the point on this plot where maximum swelling is obtained. Swelling will be less for solvents having solubility parameters that are less than or greater than that of the material. Alternatively, there are several known methods for theoretically estimating the solubility parameter of a material based on the additive contributions of functional groups.

Adhesive articles of the present disclosure may be made a variety of means. In some embodiments, a dilute solution of surface-modified nanoparticles in a solvent system may be applied to one or both surfaces of the adhesive layer. The applied solution can then be dried to leave the surface-modified nanoparticles at or near the coated surface of the PSA layer.

In some embodiments, the solution comprises no greater than 10 wt. % nanoparticles, e.g., no greater than 5 wt. % nanoparticles, or even no greater than 2 wt. % nanoparticles. In some embodiments, the solution comprises at least 0.1 wt. % nanoparticles, e.g., at least 0.5 wt. %, or even at least 1 wt. % nanoparticles. In some embodiments, the solution contains between 0.3 and 3 wt. % nanoparticles, inclusive, e.g., between 0.5 and 2 wt. % nanoparticles, inclusive.

Generally, the solvent system comprises one or more solvents. The solvents should be selected such that the surface-modified nanoparticles readily disperse in the solvent system, minimizing or eliminating any particle agglomeration. In addition, the solvent system can be selected to achieve a desired degree of compatibility with the pressure sensitive adhesive. For e.g., in some embodiments, the solvent system may be selected such the solvent does not dissolve or swell the pressure sensitive adhesive. In such embodiments, the surface modified nanoparticles would tend to remain on or only partially embedded in pressure sensitive adhesive. In some embodiments, the solvent system may be selected such the solvent swells, but does not dissolve the pressure sensitive adhesive. In such embodiments, the surface modified nanoparticles would tend to penetrate some distance into the pressure sensitive adhesive, as determined by factors such as the compatibility of the surface modifying groups with the pressure sensitive adhesive.

Selecting the desired solvents is a matter of routine experimentation and estimates can be made based on the solubility parameters of the solvents relative to the pressure sensitive adhesive. For example, when the solubility parameters are significantly different, little or no swelling would occur. As the difference in solubility parameter decreases, the solvent system would begin to swell the adhesive, even to the point of creating a gel. Finally, as the difference in solubility parameter decreases even further, the solvent system will tend to dissolve the pressure sensitive adhesive.

In some embodiments, the pressure sensitive adhesive may be crosslinked to prevent dissolution in a solvent system. Such crosslinked pressure sensitive adhesives would then tend to swell even at small differences between the solubility parameters of the solvents relative to the pressure sensitive adhesive.

### EXAMPLES

The materials used to prepare the following samples are summarized in Table 1.

TABLE 1
Material summary.

| Component | Description | Source |
|---|---|---|
| ADH-1 | 3M ™ 468MP adhesive transfer tape | 3M Company, |
| | 127 micron acrylic adhesive | St. Paul, Minnesota |
| ADH-2 | Styrene-butadiene block copolymer | Prepared according |
| | adhesive | to Composition |
| | | D of U.S. Pat. |
| | | No. 6,231,962 |
| | | (Bries) |
| ADH-3 | 3M ™ 9627 adhesive transfer tape | 3M Company |
| | 127 micron acrylic adhesive. | |
| VAZO67 | Thermal initiator | DuPont Co., |
| | | Wilmington, DE |
| AA | Acrylic acid | Aldrich Chemical |
| IOA | Isooctyl acrylate | Sartomer, |
| | | Ridgefield Park, |
| | | New Jersey |
| IOTS | Isooctyl trimethoxysilane | |
| IRGACURE | 2-hydroxy-1-(4-(2-hydroxy | Ciba Specialty |
| 2959 | ethoxy)phenyl)-2-methyl- | Chemicals Inc., |
| | 1-proanone (UV photoinitiator) | Switzerland |
| Silica-1 | 5 nm ammonium-stabilized colloidal | Ondeo Nalco |
| | silica (15 wt. % solids in water) | Chemical Co., |
| | NALCO 2326 | Bedford Park, |
| | | Illinois |
| Silica-2 | 75 nm ammonium-stabilized colloidal | Ondeo Nalco |
| | silica (40 wt. % solids in water) | Chemical Co. |
| | NALCO 2329 | |
| Silica-3 | 120 nm potassium-stabilized colloidal | Ondeo Nalco |
| | silica (41 wt. % in water) | Chemical Co. |
| | NALCO TX11005 | |
| Silica-4 | Micron scale aggregates of | Evonik Degussa, |
| | a hydrophilic fumed silica, | GmbH |
| | available as AEROSIL 200 | |

### Test Methods.

90 Degree Peel Procedure. A 51 mm (two inch (in.)) wide by about 127 mm (5 in.) long high density polyethylene (HDPE, PROTEUS natural high density polyethylene available from QUADRANT Engineering Plastics Products USA, Inc., Reading, Pa.) was solvent-washed with isopropyl alcohol and dried. A 0.025 mm (0.001 in.) thick by 31.8 mm (1.25 in.) wide polyester film was placed on the HDPE panel so that the film covered about 12.7 mm (0.5 in.) of one end of the panel, in order to form a tab at the starting end of the test specimen.

A 12.7 mm (0.5 in.) wide by about 200 mm (8 in.) long sample was placed along the length of one side of the test panel. Similarly, a second test specimen of the same article was laminated to the test panel along the remaining side of the test panel and parallel to the first test specimen. The laminates were rolled down onto the panel using a 2.0 kg (4.5 lb.) steel roller, with two passes in each direction. Care was taken not to trap bubbles between the panel and the laminates.

The bonded test panel thus prepared was allowed to dwell at room temperature (about 22° C.) for 15 minutes. Then, each sample was tested at room temperature (about 22° C.) for 90 degree peel adhesion using an IMASS SP-2000 slip/peel tester (available from IMASS, Inc. of Accord, Mass.). The peel rate was set at 5 mm/minute (0.2 inch/minute) unless otherwise indicated. The average peel adhesion force required to remove the tape from the panel was recorded in ounces and expressed in Newtons/decimeter (N/dm), based on 2 replicates.

Constant-load 90 Degree Peel Procedure. Resistance to low stress peel was measured by a constant-load 90 degree peel test. A high density polyethylene (HDPE, PROTEUS natural high density polyethylene available from QUADRANT Engineering Plastics Products USA, Inc., Reading, Pa.) panel having a length of 10 cm (4 inches) was cleaned three times with isopropyl alcohol and dried. The adhesive-bearing side of a 12.7 mm (0.5 inch) wide tape sample was adhered to the cleaned HDPE panel. The tape was laminated to the HDPE panel using two passes of a 2 kg (4.5 pound) roller and allowed to dwell for 30 minutes. The testing was done in a constant temperature room at 23° C. and 50% relative humidity. The panel was suspended horizontally, and a 175 gram weight was fastened to one end of the tape sample. The constant-load peel value was recorded as the amount of time required for the tape sample to travel 6.4 cm (2.5 inches).

Static Shear Strength Procedure. Evaluation of static shear strength at 23° C./50% Relative Humidity was performed as described in ASTM D3654, Procedure A, with a 1.3 cm×1.3 cm (½ in.×½ in.) test specimen and a 1000 g load. The test panels were HDPE. The time to failure in minutes was recorded.

Adhesive Probe Procedure. Probe tests of adhesive samples were performed with a TA.XT PLUS Texture Analyzer (Stable Micro Systems Ltd., UK) in a constant temperature room at 23° C. and 50% relative humidity. During this test, a cylindrical probe (6 mm diameter) with a flat tip was brought into contact with an adhesive layer on a glass slide under a contact force for 120 seconds. For probes made of high-density polyethylene (HDPE), the contact force was 1000 grams. When a stainless steel probe was used, the contact force was set at 2000 grams. Then the probe was pulled away with a constant velocity of 0.01 mm per second until complete debonded. The force applied to the probe during debonding was recorded as a function of the probe displacement distance. The strength of the adhesive joint is given by the rupture energy, which was calculated as an integration of the force against displacement during the debonding process, i.e., the area under the force-displacement curve.

Surface modification of silica nanoparticles.

SMNP-1. Five hundred grams (g) of Silica-1 were weighed into a round bottom 3-neck flask, equipped with a mechanical stirrer and a reflux condenser and diluted with 500 ml of 2-methoxy-1-propanol. A solution of 40.42 g isooctyltrimethoxysilane in 100 ml of 2-methoxy-1-propanol was prepared separately in a beaker.

The isooctyltrimethoxysilane/methoxypropanol solution was added to the flask containing Silica-1 via the open port while the Silica-1 sol was stirred. Next, 4.28 g of IRGACURE 2959-silane was subsequently added to the mixture while stirring. After complete addition, the open port in the flask was stoppered and the flask was placed in an oil bath. The oil bath was then heated to 80° C. and the reaction was allowed to proceed for about 20 hours. The resultant sol was dried in a batch oven at 120° C. to obtain a powdery white solid identified as SMNP-1.

SMNP-2. One hundred grams (g) of Silica-2 was weighed into a round bottom 3-neck flask, equipped with a mechanical stirrer and a reflux condenser and diluted with 200 ml of 2-methoxy-1-propanol. A solution of 1.41 g isooctyltrimethoxysilane in 10 ml of 2-methoxy-1-propanol was prepared separately in a beaker.

The isooctyltrimethoxysilane/2-methoxy-1-propanol solution was added to the flask containing Silica-2 via the open port while the Silica-2 sol was stirred. After complete addition, the open port in the flask was capped with a temperature probe and the flask was placed in a heating mantle. The mixture was then heated to 80° C. and the reaction was allowed to proceed for about 20 hours. IOA monomer was added to resultant milky white solution and the mixture was placed under vacuum to remove all of the 2-methoxy-1-propanol to obtain a particle/monomer mixture in a range of 25 to 100 wt. % solids depending on the amount of IOA monomer remaining and identified as SMNP-2.

SMNP-3. A polymeric silane was prepared by thermally polymerizing 18 g of IOA and 2 g of AA using 0.0385 g VAZO 67 thermal initiator; in the presence of 1.49 g mercaptopropyl trimethoxy silane chain transfer agent in 32 g of ethyl acetate. The solution was purged with nitrogen for 20 minutes then capped and placed in a laundrometer set at 60° C. for 24 hours. The percent solids and GPC analysis showed that the molecular weight of the polymeric silane was around 3000 g/mol. The resultant polymeric silane solution was concentrated by removing some of the ethyl acetate under vacuum and final solid percent was calculated as 41.8%.

Next, one hundred grams of Silica-2 was weighed into a round bottom 3-neck flask equipped with a mechanical stirrer and a reflux condenser and diluted with 200 ml of 2-methoxy-1-propanol. A solution of 1.125 g isooctyltrimethoxysilane and 8.6 g of the polymeric silane (41.8% solids in ethyl acetate) in 20 ml of 2-methoxy-1-propanol was prepared separately in a beaker.

This isooctyltrimethoxysilane/polymeric silane solution was added to the flask containing Silica-2 via the open port while the Silica-2 sol was stirred. After complete addition, the open port in the flask was capped with a temperature probe and the flask placed in a heating mantle. The solution mixture was then heated to 80° C. and the reaction was allowed to proceed for about 20 hours. IOA monomer was added to resultant milky white solution and the mixture was placed under vacuum to remove all of the 2-methoxy-1-propanol to obtain a particle/monomer mixture in a range of 25 to 100 wt. % solids depending on the amount of IOA monomer remaining, identified as SMNP-3.

SMNP-4. First, 61 grams of polyglycol (M2000S (batch DEG067488 material #13774516890, obtained from Clariant Corporation) was added to 74.2 grams of ethyl acetate, passed through 4 angstrom sieves, and dried overnight. Next, 7.4 grams of 3-(triethoxysilyl) propyl isocyanate (Aldrich, Lot 07915TB) were added to this solution, followed by four drops of di-n-butyl tin dilaurate (Strem Chemicals, Lot 137888-5). This mixture was allowed to react at room temperature for 24 hours, after which time, ethyl acetate was removed using a BUCHI rotovap to produce Solution A.

150 grams of Silica-3 colloidal silica sol was placed in a flask equipped with a stir bar and, while stirring at room temperature, 100 grams of water was slowly added to the flask followed by 8.23 grams of Solution A. Stirring continued at room temperature (about 22° C.) for 5 minutes. The flask was then sealed and mixture reacted at 95° C. in a forced air oven for about 22 hours to produce the SMNP-4 surface-modified silica nanoparticles.

### Examples 1-10

Nanoparticle solutions were prepared by combining nanoparticle samples SMNP-1 through SMNP-4 and Silica-4 in THF at concentration of 0.01 wt. % to 2 wt. %, as shown in Table 2. The solutions were then sonicated for about 15 minutes.

For the 90 degree peel, constant load peel, and shear tests, one release liner on an adhesive transfer tape was removed and the exposed adhesive surface was laminated to the chemically treated side of a clear polyester film having a thickness of 50 microns (0.002 inch). For the probe test, one release liner on an adhesive transfer tape was removed and the exposed adhesive surface was laminated to a microscope glass slide.

After lamination to the desired support, the release liner covering the adhesive surface on the opposite side of the adhesive transfer tape was removed. Particles were then deposited on the exposed side of the adhesive by dipping the test specimens into one of the nanoparticle solutions and withdrawing it, all vertically in one fast and continuous motion. The sample was then dried in an oven for 15 minutes at 70° C. and for an additional 15 minutes 85° C.

The dilute solutions of nanoparticles and the rapid dip-coating procedure resulted in relatively low concentrations of nanoparticles located primarily on or near the surface of the adhesive, e.g., partially or fully embedded within the adhesive. The presence of the THF solvent in the dip coating solutions likely resulted in some softening of the adhesive surface. This, combined with the compatibility of the surface modified nanoparticles and the adhesive, may contribute to some penetration of some nanoparticles into the surface of the adhesive. However, as compared to adhesives prepared with nanoparticles dispersed throughout the bulk of the adhesive, the nanoparticles of the adhesives of the present disclosure are highly concentrated near the surface of the adhesive.

In some embodiments, at least 80 wt. %, e.g., at least 90 wt. %, or even at least 95 wt. % of the nanoparticles are located within the region extending from on a surface of the adhesive to a depth of five times the average diameter of the nanoparticles from that surface. For example, with 20 nm nanoparticles, at least 80 wt. %, e.g., at least 90 wt. %, or even at least 95 wt. % of the nanoparticles are located within the region extending from on a surface of the adhesive to a depth of 100 nm from that surface, or 5 times the average diameter of 20 nm. With 75 nm nanoparticles, at least 80 wt. %, e.g., at least 90 wt. %, or even at least 95 wt. % of the nanoparticles are located within the region extending from on a surface of the adhesive to a depth of 375 nm from that surface. In some embodiments, regardless of the average diameter to the nanoparticles, at least 80 wt. %, e.g., at least 90 wt. %, or even at least 95 wt. % of the nanoparticles are located within the region extending from on a surface of the adhesive to a depth of 500 nm from that surface of the adhesive, e.g., to a depth of 250 nm from the surface of the adhesive.

In some embodiments, surface-modified nanoparticles may be applied to both surface of an adhesive layer. In such embodiments, at least 80 wt. %, e.g., at least 90 wt. %, or even at least 95 wt. % of the nanoparticles are located within a first region extending from on a first surface of the adhesive to a depth of five times the average diameter of the nanoparticles from that first surface and within a second region extending from on a second surface of the adhesive to a depth of five times the average diameter of the nanoparticles from that second surface. In some embodiments, regardless of the average diameter to the nanoparticles, at least 80 wt. %, e.g., at least 90 wt. %, or even at least 95 wt. % of the nanoparticles are located within a first region extending from on a first surface of the adhesive to a depth of 500 nm from that first surface of the adhesive, e.g., to a depth of 250 nm from that first surface of the adhesive and within a second region extending from on a second surface of the adhesive to a depth of 500 nm from that second surface of the adhesive, e.g., to a depth of 250 nm from that second surface of the adhesive.

Generally, the relative distribution of nanoparticles within the first and second regions can vary as desired for a particular application. For example, in some embodiments, the ratio of the weight fraction of nanoparticles in the first region over the weight fraction of nanoparticles in the second region, based on the total weight of all nanoparticles within the first and second regions will be about 1, e.g., ranging from 0.5 to 2, in some embodiments, from 0.8 to 1.2, or even from 0.9 to 1.1. In some embodiments, the ratio of the weight fraction of nanoparticles in the first region over the weight fraction of nanoparticles in the second region, based on the total weight of all nanoparticles within the first and second regions may be at least 3, e.g., at least 5, or even at least 10.

The adhesive tapes, nanoparticle samples, and particle concentrations for Examples 1-9 and Comparative Examples 1-5 are listed in Table 2.

TABLE 2
Summary of example constructions.

| | | | Particle | |
|---|---|---|---|---|
| | | Surface-modifying | conc. | |
| Ex. | SILICA | agent | (wt. %) | Adhesive |
| CE-1 | None | — | 0.0 | ADH-3 |
| EX-1 | SMNP-1 | isooctyltrimethoxysilane | 0.1 | ADH-3 |
| EX-2 | SMNP-1 | isooctyltrimethoxysilane | 0.5 | ADH-3 |
| EX-3 | SMNP-1 | isooctyltrimethoxysilane | 1.0 | ADH-3 |
| EX-4 | SMNP-1 | isooctyltrimethoxysilane | 2.0 | ADH-3 |
| EX-5 | SMNP-2 | isooctyltrimethoxysilane | 1.0 | ADH-3 |
| EX-6 | SMNP-3 | isooctyltrimethoxysilane and | 1.0 | ADH-3 |
| | | polymerized IOA/AA silane | | |
| CE-2 | SMNP-4 | polyglycol | 0.2 | ADH-3 |
| CE-3 | Silica-4 | — | 0.05 | ADH-3 |
| CE-4 | None | — | 0.0 | ADH-1 |
| EX-7 | SMNP-3 | isooctyltrimethoxysilane and | 0.01 | ADH-1 |
| | | polymerized IOA/AA silane | | |
| CE-5 | None | — | 0.0 | ADH-2 |
| EX-8 | SMNP-3 | isooctyltrimethoxysilane and | 1.0 | ADH-2 |
| | | polymerized IOA/AA silane | | |

Testing was performed after conditioning the test specimens for 20 minutes in a constant temperature room at 23° C. and 50% relative humidity. The 90 Degree Peel Procedure was used to evaluate the peel performance of Comparative Example CE-1 and Example EX-3 at various peel speeds. The results are summarized in Table 3. As shown, the addition of surface-modified nanoparticles significantly increased the low speed peel force and resulted in a more uniform peel force across the full range of peel speeds.

TABLE 3
Effect of peel speed on 90° Peel force.

| | | 90° Peel (N/dm) | | | |
|---|---|---|---|---|---|
| | Particle | | | | 162 |
| Ex. | conc. (wt. %) | 0.5 cm/min | 22 cm/min | 54 cm/min | cm/min |
| CE-1 | 0.0 | 19 | 52 | 71 | 66 |
| EX-3 | 1.0 | 27 | 42 | 33 | 21 |

Various low speed adhesion tests were conducted using adhesives dip-coated with various surface modified nanoparticles (SMNP-1 through SMMP-4) and Silica-4. The results are summarized in Tables 4 and 5.

TABLE 4
Summary of examples and peel and shear test results.

| | | | | | | Constant |
|---|---|---|---|---|---|---|
| | | Particle | | 90° Peel | Static | load 90° |
| | | conc. | Adhe- | at 0.5 cm/ | Shear | peel |
| Ex. | SILICA | (wt. %) | sive | min (N/dm) | (min.) | (min.) |
| CE-1 | None | 0.0 | ADH-3 | 19 | 344 | 420 |
| EX-3 | SMNP-1 | 1.0 | ADH-3 | 27 | 4454 | 4436 |
| EX-5 | SMNP-2 | 1.0 | ADH-3 | N/A | NA | 545 |
| EX-6 | SMNP-3 | 1.0 | ADH-3 | 34 | 2053 | 1220 |
| CE-2 | SMNP-4 | 0.2 | ADH-3 | 22 | 175 | N/A |
| CE-3 | Silica-4 | 0.05 | ADH-3 | 27 | 162 | 167 |

TABLE 5
Summary of examples and probe tack results.

| | | Particle | | | Rupture |
|---|---|---|---|---|---|
| | | conc. | | | Energy |
| Ex. | SILICA | (wt. %) | Adhesive | Probe material | (N * mm) |
| CE-1 | None | 0.0 | ADH-3 | HDPE | 5.4 |
| EX-1 | SMNP-1 | 0.1 | ADH-3 | HDPE | 6.1 |
| EX-2 | SMNP-1 | 0.5 | ADH-3 | HDPE | 7.1 |
| EX-3 | SMNP-1 | 1.0 | ADH-3 | HDPE | 7.2 |
| EX-4 | SMNP-1 | 2.0 | ADH-3 | HDPE | 3.8 |
| EX-5 | SMNP-2 | 1.0 | ADH-3 | HDPE | N/A |
| EX-6 | SMNP-3 | 1.0 | ADH-3 | HDPE | 8.9 |
| CE-2 | SMNP-4 | 0.2 | ADH-3 | HDPE | 4.8 |
| CE-3 | Silica-4 | 0.05 | ADH-3 | HDPE | 5.1 |
| CE-4 | None | 0.0 | ADH-1 | SS | 12 |
| EX-7 | SMNP-3 | 0.01 | ADH-1 | SS | 16.8 |
| CE-5 | None | 0.0 | ADH-2 | HDPE | 7.9 |
| EX-8 | SMNP-3 | 1.0 | ADH-2 | HDPE | 13 |

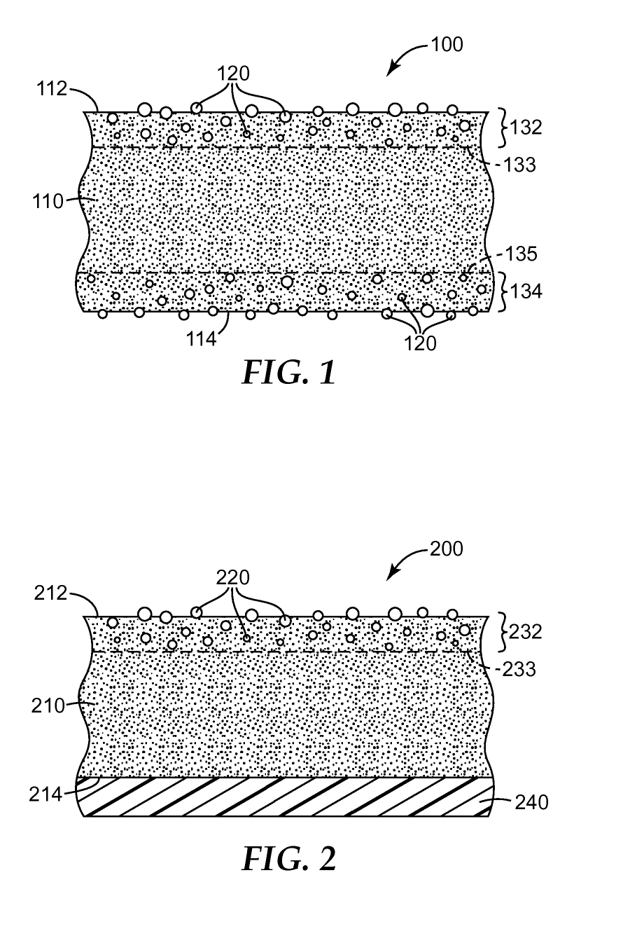

The adhesives of the present disclosure can be used to prepare a wide variety of adhesive articles including free and supported films, single sided tapes, double sided tapes, laminating adhesives and the like. Exemplary adhesive articles according to some embodiments of the present disclosure are illustrated in FIGS. 1 and 2.

Referring to FIG. 1, adhesive article 100 comprises adhesive layer 110 having first surface 112 and second surface 114. Surface-modified nanoparticles 120 are located within first region 132 extending from on first 112 to some depth 133 near first surface 112. Similarly, surface-modified nanoparticles 120 are also located within second region 134 extending from on first 114 to some depth 135 near surface 114.

Referring to FIG. 2, adhesive article 200 comprises adhesive layer 210 having first surface 212 and second surface 214. Surface-modified nanoparticles 220 are located within first region 232 extending from on first surface 212 to some depth 233 near surface 112. Second surface 214 of adhesive layer 210 is adjacent substrate 240. In some embodiments, substrate 240 may be a release liner such that adhesive layer 210 may be removed from substrate 240. In some embodiments, adhesive layer 210 may be more permanently bonded to substrate 240, either directly or indirectly with one or more layers, e.g., a primer layer, located between adhesive layer 210 and substrate 240. Any of a wide variety of substrates may be used including, e.g., paper, polymers (e.g., polyolefins and polyesters), foams, scrims, woven and non-woven films and the like.

Additional layers may be included in the adhesive articles of the present disclosure, including the exemplary adhesive articles of FIGS. 1 and 2. For example, in some embodiments, one or more layers may be embedded in the pressure sensitive adhesive layers. Generally any know layer may be used include papers, polymer films, scrims, woven and non-woven films, foams and the like.

Various modifications and alterations of this invention will become apparent to those skilled in the art without departing from the scope and spirit of this invention.

1. An adhesive article comprising a layer of a pressure sensitive adhesive comprising a first surface and a second surface, and a plurality of surface modified nanoparticles having an average diameter of Davg as measured by the TEM method, wherein at least 80% by weight of the surface modified nanoparticles are located within at least one of a first region extending from on the first surface to a depth of five times Davg from the first surface and a second region extending from on the second surface to a depth of five times Davg from the second surface.

2. The adhesive article of claim 1, wherein at least 80% by weight of the surface modified nanoparticles are located within a first region extending from on the first surface to a depth of five times Davg from the first surface.

3. An adhesive article comprising a layer of a pressure sensitive adhesive comprising a first surface and a second surface, and a plurality of surface modified nanoparticles having an average diameter of Davg, wherein at least 80% by weight of the surface modified nanoparticles are located within at least one of a first region extending from on the first surface to a depth 500 nm from the first surface and a second region extending from on the second surface to a depth of 500 nm from the second surface.

4. The adhesive article of claim 3, wherein at least 80% by weight of the surface modified nanoparticles are located within a first region extending from on the first surface to a depth of 500 nm from the first surface.

5. The adhesive article according to claim 1, wherein the surface modified nanoparticles comprise a silica core.

6. The adhesive article of claim 5, wherein the surface modified nanoparticles further comprises a surface modifying agent comprising a binding group attached to the surface of the core and a compatiblizing group.

7. The adhesive article of claim 6, wherein the difference between the solubility parameters of the pressure sensitive adhesive and the solubility parameter of the compatiblizing group is no more than 4 J^{1/2} cm^{-3/2} as determined by the Additive Group Contribution Method.

8. The adhesive article according to claim 1, wherein the adhesive is crosslinked.

9. The adhesive article according to claim 1, wherein Davg is no greater than 250 nm.

10. The adhesive article of claim 9, wherein Davg is at least 10 nm.

11. The adhesive article of claim 10, wherein Davg is between 20 and 100 nm, inclusive.

12. A method of preparing an adhesive article comprising a layer of a pressure sensitive adhesive comprising a first surface and a second surface, the method comprising applying a solution comprising surface-modified nanoparticles having an average diameter of Davg as measured by the TEM method dispersed in a solvent system to at least one of the first and second surfaces of the layer and drying the applied solution.

13. The method of claim 12, wherein at least 80% by weight of the surface modified nanoparticles are located within at least one of a first region extending from on the first surface to a depth of five times Davg from the first surface and a second region extending from on the second surface to a depth of five times Davg from the second surface.

14. The method of claim 13, wherein at least 80% by weight of the surface modified nanoparticles are located within a first region extending from on the first surface to a depth of five times Davg from the first surface.

15. The method of claim 12, wherein at least 80% by weight of the surface modified nanoparticles are located within at least one of a first region extending from on the first surface to a depth 500 nm from the first surface and a second region extending from on the second surface to a depth of 500 nm from the second surface.

16. The method of claim 15, wherein at least 80% by weight of the surface modified nanoparticles are located within a first region extending from on the first surface to a depth of 500 nm from the first surface.

17. The method according to claim 12, wherein the surface modified nanoparticles comprise a silica core.

18. The method of claim 17, wherein the surface modified nanoparticles further comprises a surface modifying agent comprising a binding group attached to the surface of the core and a compatiblizing group.

19. The method of claim 18, wherein the difference between the solubility parameters of the pressure sensitive adhesive and the solubility parameter of the compatiblizing group is no more than 4 J^{1/2} cm^{-3/2} as determined by the Additive Group Contribution Method.

20. The method according to claim 12, wherein the adhesive is crosslinked.

21. The method according to claim 12, wherein Davg is no greater than 250 nm.

22. The method of claim 21, wherein Davg is at least 10 nm.

23. The method of claim 22, wherein Davg is between 20 and 100 nm, inclusive.

24. The method according to claim 12, wherein the solution comprises between 0.5 and 2 wt. % surface-modified nanoparticles.

25. The method according to claim 12, wherein the solubility parameter of the solvent is selected such that the solvent swells but does not dissolve the pressure sensitive adhesive.
